(19) United States
(12) Patent Application Publication
(10) Pub. No.: US 2009/0228845 A1
(43) Pub. Date: Sep. 10, 2009

(54) Method, design program and design system for semiconductor device

(75) Inventors: Nobuyuki Ito, Kanagawa (JP); Kimie Baba, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/379,589

(22) Filed: Feb. 25, 2009

(30) Foreign Application Priority Data
Mar. 6, 2008 (JP) 2008-056713

(51) Int. Cl. G06F 17/50

(52) U.S. Cl. 716/4

(57) ABSTRACT

A method of designing a semiconductor device includes: calculating a design value of a noise parameter based on design specification of the semiconductor device. The noise parameter contributes to power-supply noise of the semiconductor device. The method further includes: setting the noise parameter variably within a predetermined range including the calculated design value; calculating amount of power-supply noise of the semiconductor device by using the set noise parameter; and generating a noise database indicating correspondence relationships between the noise parameter within the predetermined range and the calculated amount of power-supply noise.

### INCORPORATION BY REFERENCE

This application is based upon and claims the benefit of priority from Japanese patent application No. 2008-056713, filed on Mar. 6, 2008, the disclosure of which is incorporated herein in its entirely by reference.

### BACKGROUND OF THE INVENTION

1. Field of the Invention

The present invention relates to a design technique for a semiconductor device. In particular, the present invention relates to a design technique considering power-supply noise of a semiconductor device.

2. Description of Related Art

With speeding up and increasing miniaturization of a semiconductor device, malfunctions caused by power-supply noise have become a problem. It is therefore desirable to design a semiconductor device with taking the power-supply noise into consideration to prevent the malfunctions. In order to reduce the power-supply noise, modification of a chip size, a semiconductor package or the like may be necessary. Such a modification of design specification of the semiconductor device is a back-track, which causes increase in a design time. It is therefore desirable to estimate the amount of power-supply noise in a phase of considering the design specification and to reflect results of the estimation in designing.

Japanese Laid-Open Patent Application JP-2006-163494 discloses a technique of estimating the amount of power-supply noise prior to circuit design processing, particularly prior to logic synthesis of a design circuit. First, a power-supply network model from a power supplying section to a ground section of a semiconductor device is created based on electrical characteristics required by specification of the semiconductor device. Subsequently, a frequency analysis for the power-supply network model is performed. Moreover, another frequency analysis is performed based on an operating current waveform obtained in accordance with the above-mentioned specification. Then, power-supply noise of the power-supply network model is calculated based on results of these two frequency analyses. Consequently, the power-supply noise is comprehended prior to logic synthesis.

The inventors of the present application have recognized the following points. According to the above-described related technique, the amount of power-supply noise can be estimated prior to the logic synthesis. If the estimated amount of power-supply noise exceeds an acceptable amount, it is 5 necessary to modify the design specification in order to reduce the power-supply noise. However, the above-described related technique does not provide a guideline on how to modify the design specification for reducing the power-supply noise. That is, it is not possible to know what of the design specification and how much of it should be modified. Thus, a designer needs to modify the design specification through a trial and error process based on experience and feel and to repeat the estimation of the power-supply noise.

### SUMMARY

In one embodiment of the present invention, a method of designing a semiconductor device is provided. The method comprises: calculating a design value of a noise parameter based on design specification of the semiconductor device, the noise parameter contributing to power-supply noise of the semiconductor device; setting the noise parameter variably within a predetermined range including the calculated design value; calculating amount of power-supply noise of the semiconductor device by using the set noise parameter; and generating a noise database indicating correspondence relationships between the noise parameter within the predetermined range and the calculated amount of power-supply noise.

In another embodiment of the present invention, a design program recorded on a computer-readable medium that, when executed, causes a computer to perform a design processing is provided. The design processing comprises: calculating a design value of a noise parameter based on design specification of a semiconductor device, the noise parameter contributing to power-supply noise of the semiconductor device; setting the noise parameter variably within a predetermined range including the calculated design value; calculating amount of power-supply noise of the semiconductor device by using the set noise parameter; and generating a noise database indicating correspondence relationships between the noise parameter within the predetermined range and the calculated amount of power-supply noise.

In still another embodiment of the present invention, a design system for designing a semiconductor device is provided. The design system comprises a memory device and a processor. A design specification data indicating design specification of the semiconductor device is stored in the memory device. The processor calculates a design value of a noise parameter based on the design specification, the noise parameter contributing to power-supply noise of the semiconductor device. The processor sets the noise parameter variably within a predetermined range including the calculated design value. The processor calculates amount of power-supply noise of the semiconductor device by using the set noise parameter. The processor generates a noise database indicating correspondence relationships between the noise parameter within the predetermined range and the calculated amount of power-supply noise.

According to the present invention, the noise database that comprehensively indicates correspondence relationships between the noise parameter within the predetermined range and the amount of power-supply noise is provided. Therefore, it is possible to easily analyze characteristics and variations of the power-supply noise by utilizing the noise database. It is also possible with reference to the noise database to immediately know a condition where the amount of power-supply noise becomes not more than an acceptable amount. There is no need to repeat a trial and error process for obtaining appropriate condition and design constraint. Consequently, the design time can be dramatically reduced.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a schematic diagram showing a design processing flow for a semiconductor device according to an embodiment of the present invention;

FIG. 2 is a schematic diagram showing an example of determination of design specification according to the embodiment of the present invention;

FIG. 3 is a flow chart showing noise estimation processing in the embodiment of the present invention;

FIG. 4 is a table showing an example of a noise database in the embodiment of the present invention;

FIG. 5 is a graph showing an example of the noise database in the embodiment of the present invention; and

FIG. 6 is a block diagram showing a configuration example of a design system according to the embodiment of the present invention.

### DETAILED DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

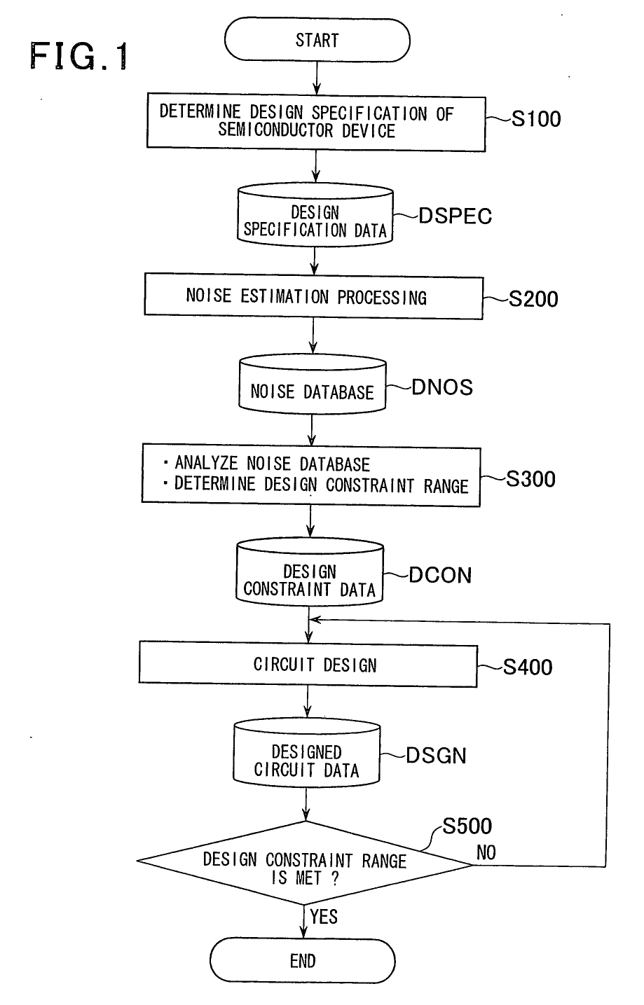

A method of designing a semiconductor device according to an embodiment of the present invention will be described with reference to the attached drawings. According to the present embodiment, amount of power-supply noise of a semiconductor device is estimated beforehand and then design and verification of the semiconductor device are performed by utilizing the estimated amount of power-supply noise. FIG. 1 schematically shows a design processing flow for a semiconductor device according to the present embodiment. The respective steps shown in FIG. 1 will be described below in detail.

1. Determination of Design Specification of Semiconductor Device (Step S100)

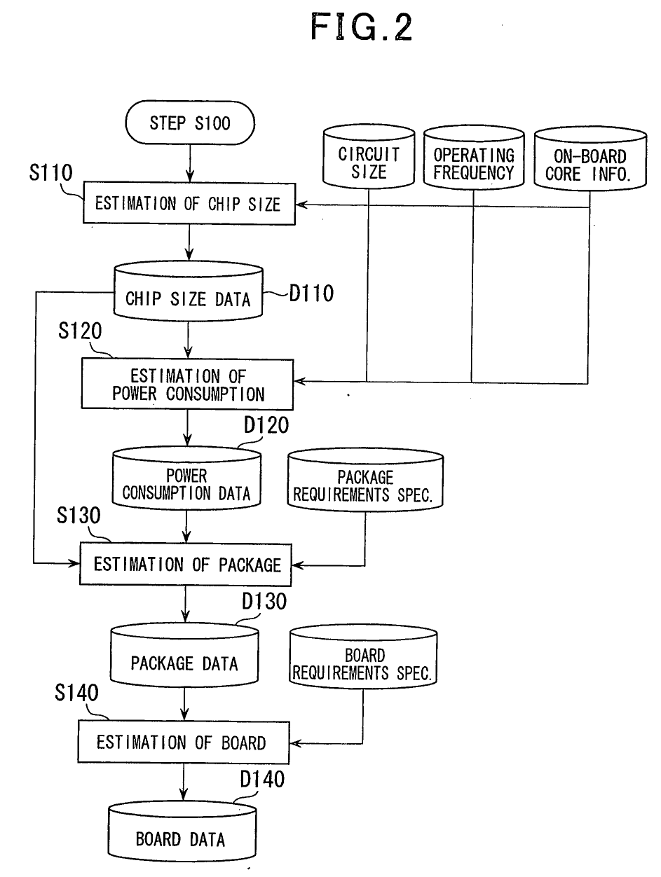

First, design specification of the semiconductor device is determined. In particular, physical specification is determined. The physical specification, which is specification of a chip size, power consumption, a package, a mounting board and the like, is used for calculating parameters that are necessary in noise estimation processing (Step S200) described later. After the design specification is determined, a design specification data DSPEC indicating the determined design specification (physical specification) is generated. FIG. 2 conceptually shows an example of processing in Step S100.

(Step S110)

A chip size is estimated based on information of circuit sizes, an operating frequency, types and the number of on-board cores and the like of the design specification. A chip size data D110 indicating the estimated chip size is generated.

(Step S120)

Power consumption of an LSI is estimated based on the above-mentioned chip size data D110 together with the information of circuit sizes, operating frequency, types and the number of on-board cores and the like. A power consumption data D120 indicating the estimated power consumption is generated.

(Step S130)

A package is estimated based on package requirements specification and the above-mentioned chip size data D110 and power consumption data D120. The package requirements specification includes a type, a shape, a body size, the number of terminals and the like of package. A package data D130 indicating a type, a structure, the number of power-supply terminals and the like of the estimated package is generated.

(Step S140)

A board (mounting board) is estimated based on board requirements specification and the above-mentioned package data D130. The board requirements specification includes material, a shape, a wiring rule, capacitances and the number of on-board bypass capacitors and the like. A board data D140 indicating a type, a structure, a size, design rule of the estimated board is generated.

The design specification data DSPEC includes at least one of the above-mentioned chip size data D110, power consumption data D120, package data D130 and board data D140.

2. Noise Estimation Processing (Step S200)

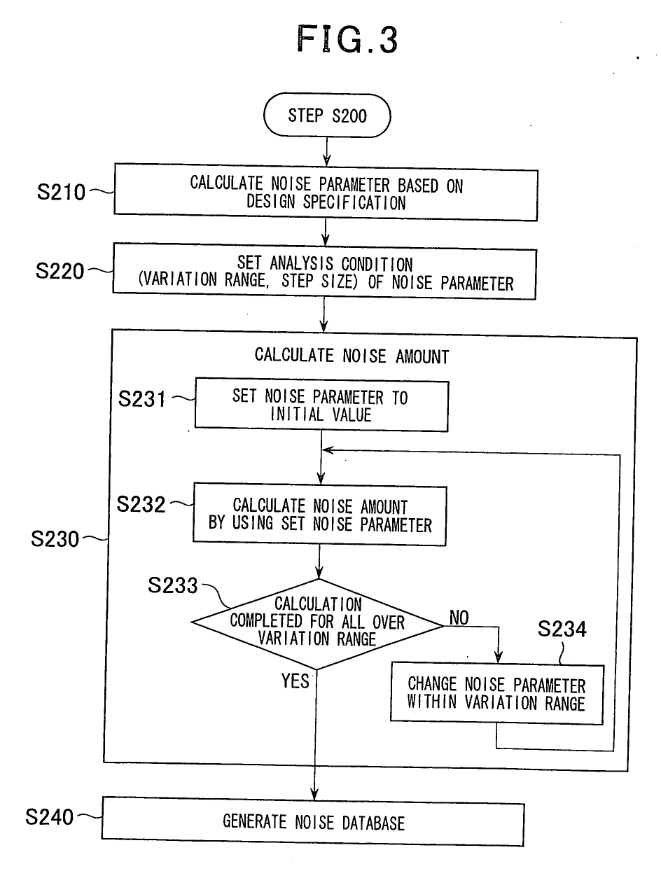

Next, estimation of the power-supply noise of the semiconductor device is performed based on the design specification data DSPEC obtained in the above Step S100. FIG. 3 shows a processing flow of Step S200.

(Step S210)

First, a design value of a noise parameter is calculated based on the design specification (physical specification) indicated by the design specification data DSPEC. The noise parameter is a parameter contributing to the power-supply noise of the semiconductor device. Examples of the noise parameter are as follows.
Cchip: static capacitance on the chip
Lchip: inductance of a power-supply wiring on the chip
Rchip: resistance of a power-supply wiring on the chip
Lpkg: loop inductance between the power-supply and the ground (GND) of the package
Cpc: capacitances and the number of bypass capacitors on the board
Rbd, Lbd, Cbd: characteristic values of a power-supply wiring on the board
US: characteristic values of a power-supply plane on the board
Ichip: LSI consumption current

Respective design values of the noise parameters Cchip, Lchip and Rchip are calculated from the chip size data D110. A design value of the noise parameter Lpkg is calculated from the package data D130. Respective design values of the noise parameters Cpc, Rbd, Lbd, Cbd and US are calculated from the board data D140. A design value of the noise parameter Ichip is calculated from the power consumption data D120.

It should be noted that the noise parameters are not limited to the examples mentioned above. Moreover, not all of the noise parameters are necessarily calculated. Arbitrary kinds of noise parameters may be calculated. For example, the design values of the static capacitance (Cchip) on the chip and the loop inductance (Lpkg) between the power-supply and GND of the package are calculated.

(Step S220)

Next, an analysis condition for the noise parameter in the power-supply noise estimation is determined. More specifically, when calculating the amount of power-supply noise, a certain error range is taken into consideration with respect to each noise parameter calculated in the above Step S210. For that purpose, a certain variation range including the above-mentioned calculated design value is set with respect to each noise parameter. The calculation of the amount of power-supply noise is performed by changing each noise parameter variously within the variation range. Therefore, a step size (analysis granularity) on changing the noise parameter is also set. Such the analysis condition (the variation range and step size) is used in the next step, i.e. applied to the calculation of the amount of power-supply noise.

(Step S230)

Next, the amount of power-supply noise is calculated by an well-known noise analysis method using circuit simulation and model. At this time, each noise parameter is set variably within the above-mentioned variation range, and thereby the amount of power-supply noise is calculated comprehensively.

As an example, let us consider a case where a certain noise parameter (e.g. Cchip) is varied within the corresponding variation range. Here, another noise parameter (e.g. Lpkg) is fixed to its design value, for example. As shown in FIG. 3, the noise parameter is first set to an initial value within the variation range (Step S231). Next, the amount of power-supply noise is calculated by using the set noise parameter (Step S232). Furthermore, the noise parameter is changed to another value within the variation range (Step S234), and then the amount of power-supply noise is calculated again (Step S232). A difference between a certain set value and the next set value of the noise parameter is defined by the above-mentioned step size. This procedure is repeated, and if the calculation is completed for all over the variation range (Step S233; Yes), the analysis of the noise parameter is completed. The same applies to the other noise parameters.

(Step S240)

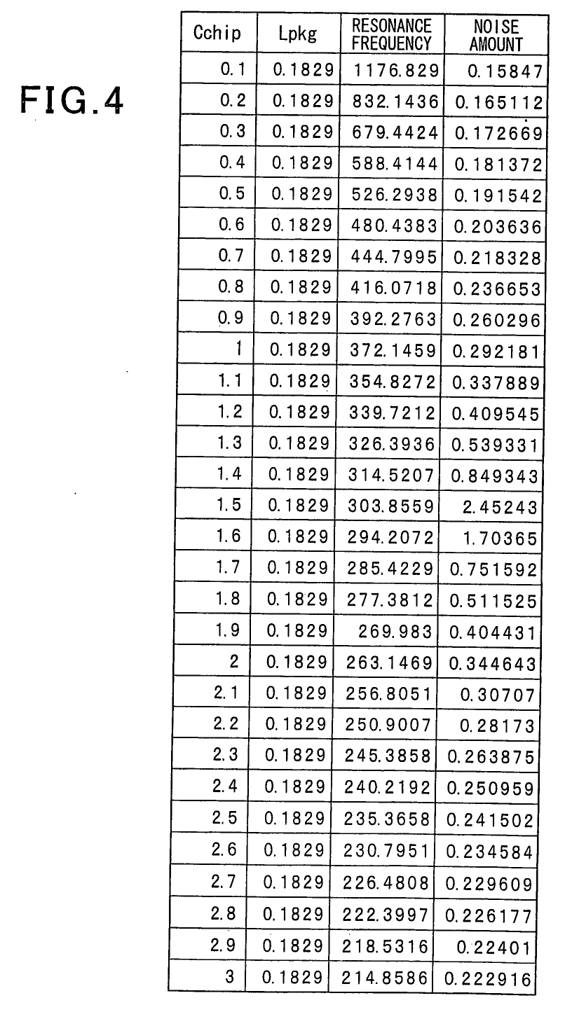

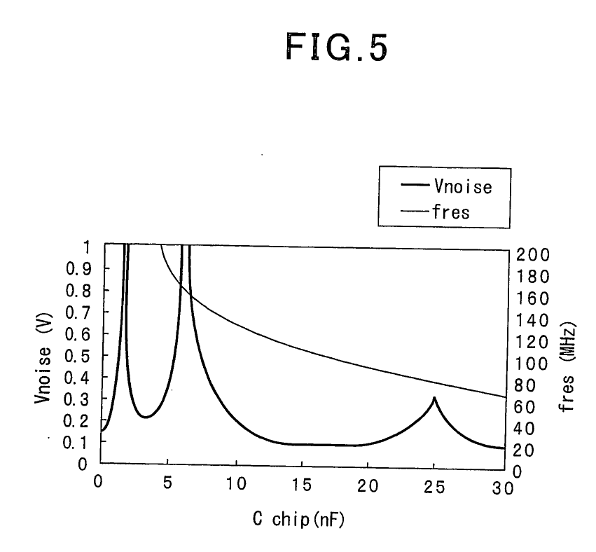

A noise database DNOS indicating the calculation results in the above Step S230 is generated. The noise database DNOS comprehensively indicates correspondence relationships between “the noise parameter within the variation range” and “the calculated amount of power-supply noise”. FIG. 4 and FIG. 5 respectively are a table and a graph for explaining one example of the obtained noise database DNOS. In the example of FIGS. 4 and 5, correspondence relationships between the noise parameter (Cchip) within the variation range and the amount of power-supply noise (Vnoise) are shown. Moreover, correspondence relationships between the noise parameter (Cchip) within the variation range and the resonance frequency (fres) are also shown. The noise database DNOS may be provided in a table form as shown in FIG. 4 or may be in a graph form as shown in FIG. 5. For example, the generated noise database DNOS is displayed on a display device.

3. Analysis of Noise Database (Step S300)

According to the present embodiment, as described above, the noise database DNOS that comprehensively indicates correspondence relationships between the noise parameter within the predetermined variation range and the amount of power-supply noise is provided. Therefore, it is possible to easily analyze characteristics and variations of the power-supply noise by utilizing the noise database DNOS. For example, it is possible to analyze how the power-supply noise changes in response to variation of a certain noise parameter. It is also possible to determine how to reduce the power-supply noise. Thus, the noise database DNOS can be a guideline on the noise analysis.

It is also possible with reference to the noise database DNOS to determine a condition where the amount of power-supply noise becomes not more than a predetermined acceptable amount. Note that the condition is given by an “acceptable range” of the noise parameter within which the amount of power-supply noise is not more than the predetermined acceptable amount. The condition (the acceptable range of the noise parameter) thus determined is used as “design constraint (constraint range)” in circuit design processing. According to the present embodiment, it is possible to immediately know the appropriate design constraint range (the acceptable range of the noise parameter) within which the amount of power-supply noise becomes not more than the predetermined acceptable amount. The reason is that the noise database DNOS that comprehensively indicates correspondence relationships between the noise parameter within the predetermined variation range and the amount of power-supply noise is referred to. There is no need to repeat a trial and error process for obtaining the appropriate condition and design constraint. Consequently, the design time can be greatly reduced.

Moreover, it is preferable that the design constraint is a feasible (reliable) one in accordance with the physical specification determined in the above Step S100. For example, in a case where the maximum capacitance that can be on a semiconductor chip having a certain chip size is 30 nF, the static capacitance Cchip is preferably not more than 30 nF. Therefore, in this case, the acceptable range of the noise parameter Cchip is so determined as to meet the condition (Cchip: not more than 30 nF). In this manner, the acceptable range of the noise parameter is so determined as to meet a condition required by the physical specification (the chip size and the like). In other words, unfeasible conditions from a viewpoint of the physical specification of the semiconductor device are excluded from the design constraint range. Since the unfeasible conditions are beforehand excluded from the design constraint range, a miss that the designed circuit is found out at a later stage to be unfeasible can be prevented from occurring. As a result, redesign and modification of the design specification can be suppressed.

A design constraint data DCON indicating the design constraint range thus determined is generated. The design constraint data DCON indicates the “acceptable range” of each noise parameter within which the amount of power-supply noise is not more than the acceptable amount. The design constraint data DCON may separately include chip constraint (design constraint regarding Cchip, Lchip, Rchip and the like), package constraint (design constraint regarding Lpkg and the like) and board constraint (design constraint regarding Cpc, Rbd, Lbd, Cbd, US and the like).

4. Circuit Design (Step S400)

After the estimation of the power-supply noise (Step S200) and determination of the design constraint range (Step S300) are performed beforehand, a circuit design of the semiconductor device is performed. More specifically, the logic synthesis and automatic layout processing are executed. At this stage of the circuit design, the above-described design constraint data DCON can be referred to. As a result of Step S400, a designed circuit data DSGN indicating the designed circuit is generated.

5. Verification of Designed Circuit (Step S500)

Next, verification of the designed circuit obtained in the above Step S400 is performed. For example, layout verification and timing verification are performed. Furthermore, noise verification is performed. In this case, whether or not the designed circuit satisfies the design constraint range (the acceptable range of the noise parameter) is checked with reference to the above-described design constraint data DCON. In a case where the verification result is FAIL (Step S500; No), the circuit design (Step S400) is performed again. On the other hand, in a case where the verification result is PASS (Step S500; Yes), the designed circuit is finally determined. According to the present embodiment, the design constraint is given by the “acceptable range” of the noise parameter within which the amount of power-supply noise is not more than the predetermined acceptable amount. In other words, the design constraint is given by the design constraint range including the acceptable error. Therefore, probability that the verification result becomes FAIL is extremely low. Consequently, the design time and design costs are dramatically reduced.

According to the present embodiment, as described above, the design constraint data DCON generated in Step S300 is referred to in Steps S400 and S500. The device design is performed such that the noise parameter of the designed circuit satisfies the acceptable range indicated by the design constraint data DCON. It should be noted that design and verification are performed in each stage of a chip stage, a package stage and a board stage.

6. Design System

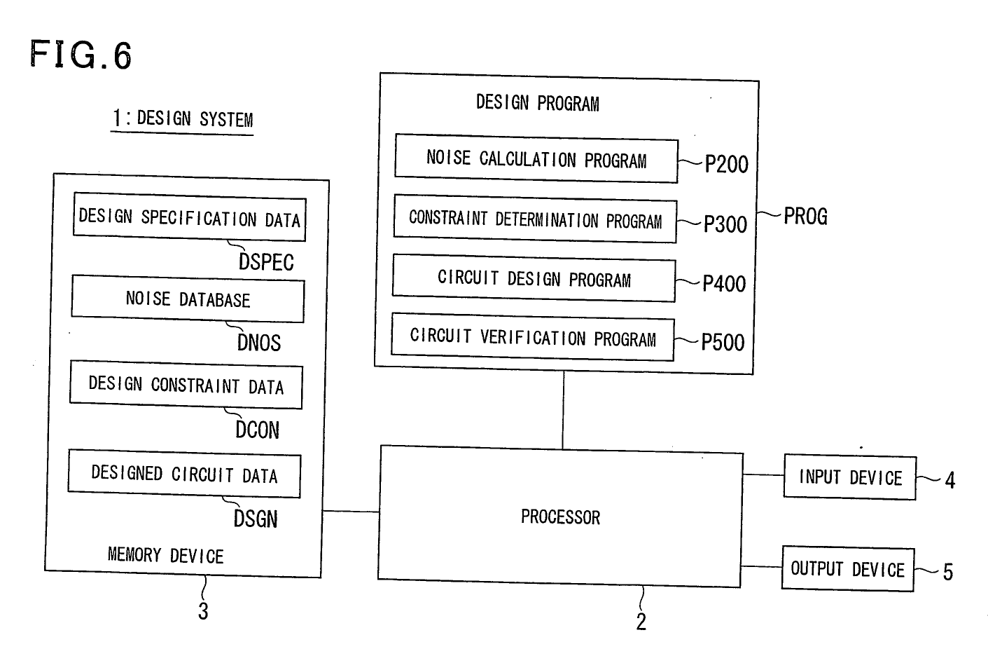

The design method according to the present embodiment can be achieved by a computer system. FIG. 6 is a block diagram showing a configuration example of the computer system.

A design system 1 (computer system) shown in FIG. 6 is provided with a processor 2, a memory device 3, an input device 4 and an output device 5. The processor 2 includes a CPU. The memory device 3 is exemplified by a RAM and a HDD. The above-mentioned design specification data DSPEC, noise database DNOS, design constraint data DCON, designed circuit data DSGN and the like are stored in the memory device 3. The input device 4 is exemplified by a key board, a mouse and a media drive. The output device 5 is exemplified by a display and a printer. A designer can refer to information output by the output device 5 and input various commands and data with the use of the input device 4.

The design system 1 is further provided with a design program PROG for the design processing. The design program PROG is a software program executed by the processor 2. The design program PROG may be stored in the memory device 3. The design program PROG may be recorded on a computer-readable recording medium. The design program PROG includes a noise calculation program P200, a constraint determination program P300, a circuit design program P400 and a circuit verification program P500. The noise calculation program P200, the constraint determination program P300, the circuit design program P400 and the circuit verification program P500 provide processing functions of the above-described Steps S200, S300, S400 and S500, respectively.

The processor 2 executes the respective programs P200 to P500, and thereby the design processing according to the present embodiment is achieved. More specifically, in accordance with the noise calculation program P200, the processor 2 reads the design specification data DSPEC from the memory device 3, performs the processing of Step S200 and generates the noise database DNOS. The noise database DNOS may be output by the output device 5. For example, a graph as shown in FIG. 5 is displayed on a display. In accordance with the constraint determination program P300, the processor 2 reads the design specification data DSPEC and the noise database DNOS from the memory device 3, performs the processing of Step S300 and generates the design constraint data DCON. In accordance with the circuit design program P400, the processor 2 performs the processing of Step S400 and generates the designed circuit data DSGN. In accordance with the circuit verification program P500, the processor 2 reads the design constraint data DCON and the designed circuit data DSGN from the memory device 3 and performs the processing of Step S500.

7. Effects

According to the present embodiment, as described above, the noise database DNOS that comprehensively indicates correspondence relationships between the noise parameter within the predetermined range and the amount of power-supply noise is provided. It is possible to easily analyze characteristics and variations of the power-supply noise by utilizing the noise database DNOS. It is also possible with reference to the noise database DNOS to immediately know an appropriate condition (design constraint) where the amount of power-supply noise becomes not more than the acceptable amount. There is no need to repeat a trial and error process for obtaining the appropriate condition and design constraint. Consequently, the design time can be dramatically reduced.

Moreover, according to the present embodiment, the design constraint is given by the “acceptable range” of the noise parameter within which the amount of power-supply noise is not more than the acceptable amount. In other words, the design constraint is given by the design constraint range including the acceptable error. As a comparative example, let us consider a case where the design constraint is given by a “specific value” of the noise parameter. In this case, probability that an actually designed circuit satisfies the design constraint is very low, even if the design constraint is taken into consideration in the circuit design process. Therefore, a result of the circuit verification is more likely to FAIL, which increases the number of redesign times. Alternatively, the estimation and verification of the power-supply noise need to be performed again in the circuit verification. These cause increase in the design time and design costs. On the other hand, in the circuit verification (Step S500) according to the present embodiment, it is just necessary to check whether or not the designed circuit satisfies the design constraint range. Since the design constraint includes the acceptable error, the probability that the result of the circuit verification (Step S500) becomes FAIL is extremely low. Consequently, the design time and design costs are dramatically reduced.

Furthermore, according to the present embodiment, the unfeasible conditions from a viewpoint of the physical specification (the chip size and the like) of the semiconductor device can be excluded from the design constraint range. Since the unfeasible conditions are beforehand excluded from the design constraint range, a miss that the designed circuit is found out at a later stage to be unfeasible can be prevented from occurring. As a result, redesign and modification of the design specification can be suppressed. This also contributes to reduction of the design time and design costs.

It is apparent that the present invention is not limited to the above embodiments and may be modified and changed without departing from the scope and spirit of the invention.

What is claimed is:

1. A method of designing a semiconductor device, comprising:
calculating a design value of a noise parameter based on design specification of said semiconductor device, said noise parameter contributing to power-supply noise of said semiconductor device;
setting said noise parameter variably within a predetermined range including said calculated design value;
calculating amount of power-supply noise of said semiconductor device by using said set noise parameter; and
generating a noise database indicating correspondence relationships between said noise parameter within said predetermined range and said calculated amount of power-supply noise.

2. The method according to claim 1, further comprising:
referring to said noise database to determine an acceptable range of said noise parameter within which said calculated amount of power-supply noise is not more than a predetermined acceptable amount; and
generating a design constraint data indicating said acceptable range of said noise parameter.

3. The method according to claim 2,
wherein said acceptable range of said noise parameter is so determined as to further meet a condition required by physical specification of said semiconductor device.

4. The method according to claim 2, further comprising:
performing a circuit design of said semiconductor device by referring to said design constraint data such that said noise parameter satisfies said acceptable range.

5. The method according to claim 1,
wherein said design specification of said semiconductor device includes information of at least one of a chip size, power consumption, a package and a board.

6. A design program recorded on a computer-readable medium that, when executed, causes a computer to perform a design processing comprising:
calculating a design value of a noise parameter based on design specification of a semiconductor device, said noise parameter contributing to power-supply noise of said semiconductor device;
setting said noise parameter variably within a predetermined range including said calculated design value;
calculating amount of power-supply noise of said semiconductor device by using said set noise parameter; and
generating a noise database indicating correspondence relationships between said noise parameter within said predetermined range and said calculated amount of power-supply noise.

7. A design system for designing a semiconductor device, comprising:
a memory device in which a design specification data indicating design specification of said semiconductor device is stored; and
a processor configured to calculate a design value of a noise parameter based on said design specification, said noise parameter contributing to power-supply noise of said semiconductor device, to set said noise parameter variably within a predetermined range including said calculated design value, to calculate amount of power-supply noise of said semiconductor device by using said set noise parameter, and to generate a noise database indicating correspondence relationships between said noise parameter within said predetermined range and said calculated amount of power-supply noise.
